(19) United States
(12) Patent Application Publication
(10) Pub. No.: US 2013/0234937 A1
(43) Pub. Date: Sep. 12, 2013

(54) THREE-DIMENSIONAL POSITION SPECIFICATION METHOD

(71) Applicant: CANON KABUSHIKI KAISHA, Tokyo (JP)

(72) Inventor: Naoto Abe, Machida-shi (JP)

(73) Assignee: CANON KABUSHIKI KAISHA, Tokyo (JP)

(21) Appl. No.: 13/767,277

(22) Filed: Feb. 14, 2013

(30) Foreign Application Priority Data
Mar. 8, 2012 (JP) 2012-051900
Sep. 3, 2012 (JP) 2012-193478

(51) Int. Cl. G06F 3/0346

(52) U.S. Cl. CPC G06F 3/0346
USPC 345/157

(57) ABSTRACT

In a viewer which acquires an image in a depth position from three-dimensional image data and displays the image, a three-dimensional position specification method for specifying three-dimensional positions in the X, Y and Z directions using a pointing device capable of performing two-dimensional moving operation of a position in the X and Y directions is executed. In the viewer, a position in the X direction on the display image is specified by moving the pointing device in the X direction; a position in the Y direction on the display image is specified by moving the pointing device in the Y direction; and a position in the depth direction of the display image is specified by moving the pointing device in a diagonal direction.

### BACKGROUND OF THE INVENTION

1. Field of the Invention

The present invention relates to a method for specifying a three-dimensional position using a two-dimensional pointing device.

2. Description of the Related Art

A method of using a special pointing device has been available as a method for specifying a three-dimensional position using a pointing device (Japanese Patent Application Laid-Open No. H6-59811). For example, Japanese Patent Application Laid-Open No. H6-59811 discloses a technique to specify coordinate positions in the X, Y and Z directions using a special mouse that includes a plurality of balls. As a method of using a standard pointing device, Japanese Patent Application Laid-Open No. 2007-148548 discloses a technique to specify a three-dimensional area by combining operation to operate a button and a wheel disposed on a mouse, with moving operation of the mouse. Further, as a method for converting a two-dimensional coordinate change amount into a three-dimensional coordinate change amount using a standard pointing device, such as a mouse, a method disclosed in Japanese Patent Application Laid-Open No. 2009-93666 is available. According to the method disclosed in Japanese Patent Application Laid-Open No. 2009-93666, a three-dimensional coordinate change amount can be specified using a standard mouse.

The present inventors have been conducting research and development on a system for observing an image captured by a digital microscope, called a “virtual microscope”, using observation software called a “viewer”.

Lately in the field of digital microscopes and various inspection apparatuses, three-dimensional image data representing a three-dimensional structure of a test object is acquired by imaging a plurality of two-dimensional images of which positions in the depth direction are different. Such three dimensional image data is also called “Z stack image data”, and each two-dimensional image data constituting Z stack image data is also called “layer image data”. By displaying a three-dimensional image using a viewer, diagnosis and inspection (hereafter called “observation”) can be performed on a screen of the display device.

A user who observes a test object (hereafter called “observer”) specifies positions in the plane directions (XY directions) and the depth direction (Z direction) of the three-dimensional image data using the viewer, and displays and observes an image of a desired area on the screen of the display device. For the input device for specifying a position, such a pointing device as a mouse is normally used, but there has been no method for specifying positions in three-dimensional directions that matches with the experiences and sensibilities of an observer.

According to the method disclosed in Japanese Patent Application Laid-Open No. H6-59811, that is the method for disposing a plurality of balls in a mouse and generating moving distance data in the depth direction of a virtual space based on the rotation amount of the plurality of balls, a position in the depth direction (Z direction) in the virtual space can be specified. However, in this method according to Japanese Patent Application Laid-Open No. H6-59811, a special mouse is required to specify positions in the three-dimensional image data. Furthermore a position in the Z direction is specified on the basis of the difference of rotation amount values of the plurality of balls, in other words, the mouse must be operated in the rotating direction. Since this method is not compatible with the experiences and sensibilities of the observer, the observer cannot operate the mouse intuitively, and must learn how to operate the mouse.

According to the method disclosed in Japanese Patent Application Laid-Open No. 2007-148548, on the other hand, that is according to the method of combining operation of a button and a wheel with moving operation of the mouse, positions in three-dimensional directions can be specified without requiring a special mouse. However this method according to Japanese Patent Application Laid-Open No. 2007-148548 as well requires operation of the button and the wheel of the mouse in addition to operation to move the mouse in order to specify positions of the three-dimensional data, therefore the observer cannot operate the mouse intuitively and must learn how to operate the mouse.

According to the method disclosed in Japanese Patent Application Laid-Open No. 2009-93666, a three-dimensional coordinate change amount can be specified without using a special mouse. However the change amounts of a cursor or the like on the display in the X, Y and Z directions are calculated on the basis of the change amounts of the mouse in the X and Y directions, therefore even if the observer wants to move a cursor or the like only in the X and Y directions, movement in the Z direction occurs. Therefore this method is very difficult to be used for observing the Z stack image data using the viewer.

### SUMMARY OF THE INVENTION

With the foregoing in view, it is an object of the present invention to provide a technique to intuitively specify positions in the three-dimensional directions without requiring a special pointing device and without learning special operation.

The present invention in its first aspect provides a three-dimensional position specification method for specifying three-dimensional positions in the X, Y and Z directions using a pointing device capable of performing two-dimensional moving operation of a position in the X and Y directions, comprising the steps of:

specifying a position in the X direction by moving the pointing device in the X direction;

specifying a position in the Y direction by moving the pointing device in the Y direction; and

specifying a position in the Z direction by moving the pointing device in a diagonal direction.

The present invention in its second aspect provides a three-dimensional position specification method for specifying three-dimensional positions in the X, Y and Z directions in a viewer which acquires an image in a depth position from three-dimensional image data and displays the image using a pointing device capable of performing two-dimensional moving operation of a position in the X and Y directions, comprising the steps of:

specifying a position in the X direction on the display image by moving the pointing device in the X direction;

specifying a position in the Y direction on the display image by moving the pointing device in the Y direction; and

specifying a position in the depth direction of the display image by moving the pointing device in a diagonal direction.

The present invention in its third aspect provides a three-dimensional position specification method for specifying three-dimensional positions in the X, Y and Z directions using a pointing device capable of performing two-dimensional moving operation of a position in the X and Y directions, comprising the steps of:

a computer determining whether the moving operation by the pointing device is a predetermined moving in the X direction, a predetermined moving in the Y direction, or a predetermined moving in a diagonal direction; and

the computer moving a movement target in the X direction if the moving operation by the pointing device is the moving in the X direction, the computer moving the movement target in the Y direction if the moving operation by the pointing device is the moving in the Y direction, and the computer moving the movement target in the Z direction if the moving operation by the pointing device is the moving in the diagonal direction.

The present invention in its fourth aspect provides a three-dimensional position specification method for specifying three-dimensional positions in the X, Y and Z directions in a viewer which acquires an image in a depth position from three-dimensional image data and displays the image using a pointing device capable of performing two-dimensional moving operation of a position in the X and Y directions, comprising the steps of:

a computer determining whether the moving operation by the pointing device is a predetermined moving in the X direction, a predetermined moving in the Y direction, or a predetermined moving in a diagonal direction; and

the computer moving the display image or a cursor in the X direction if the moving operation by the pointing device is the moving in the X direction, the computer moving the display image or the cursor in the Y direction if the moving operation by the pointing device is the moving in the Y direction, and the computer changing the position of the display image in the depth direction if the moving operation by the pointing device is the moving in the diagonal direction.

The present invention in its fifth aspect provides a non-transitory computer readable medium storing a program for a computer to execute each step of the three-dimensional position specification method according to the present invention.

According to the present invention, positions in the three-dimensional directions can be intuitively specified without requiring a special pointing device, and without learning special operation.

Further features of the present invention will become apparent from the following description of exemplary embodiments with reference to the attached drawings.

### BRIEF DESCRIPTION OF THE DRAWINGS

FIG. 1 is a flow chart depicting operation of a viewer according to Embodiment 1;

FIG. 2 is a schematic diagram depicting a method for calculating a moving direction and a moving velocity of a mouse;

FIG. 3 is a diagram depicting a method for determining operation of the viewer in the moving direction of the mouse;

FIGS. 4A and 4B are diagrams depicting an example of a guide image according to Embodiment 2;

FIGS. 5A and 5B are diagrams depicting another example of the guide image according to Embodiment 2;

FIG. 6 is a flow chart depicting operation of the viewer according to Embodiment 3;

FIG. 7 is a diagram depicting a configuration of a computer system where the viewer is running; and

FIGS. 8A and 8B are schematic diagrams for simply explaining Z stack image data.

### DESCRIPTION OF THE EMBODIMENTS

The present invention is related to a method for easily and intuitively specifying positions in three-dimensional directions using a standard pointing device, in a viewer for displaying image data having a three-dimensional structure. Examples of the image data having a three-dimensional structure (three-dimensional image data) are a plurality of pieces of two-dimensional data acquired by imaging the object while changing the position in the depth direction using a digital microscope or various inspection apparatuses (Z stack image data) and voxel data. Particularly in a system where images are captured by a digital microscope and observed using a viewer (a digital microscope system that is also called a “virtual microscope”), the present invention provides a suitable method for specifying (or changing) positions in three-dimensional directions using a pointing device. Embodiments of the present invention will now be described using an example of viewer operation to observe Z stack image data acquired by the digital microscope system.

(Z Stack Image Data)

Z stack image data captured by the digital microscope system will be described first.

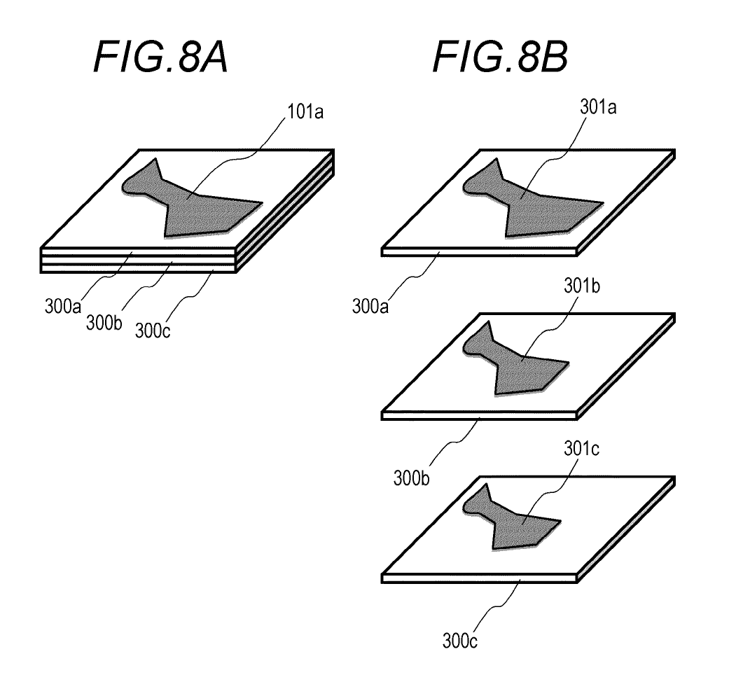

FIG. 8A and FIG. 8B are schematic diagrams for a simple explanation of Z stack image data. FIG. 8A is a schematic diagram depicting Z stack image data constituted by three layer images. FIG. 8B is a schematic diagram depicting each layer image individually. The number of layer images is not limited to 3, but Z stack image data can be created with the number of layers requested by the observer (desired number of layers).

In FIG. 8A and FIG. 8B, 300a, 300b and 300c schematically show the layer image data of respective layers. Each of layer image data: 300a, 300b and 300c, was imaged with a different focal position (focused position), and each of test object images 301a, 301b and 301c corresponding to each cross-section of a test object 101a appears on each layer image data. Each of layer image data 300a to 300c is two-dimensional image data, and each pixel is constituted by RGB 8-bit data, for example. The Z stack image data is three-dimensional image data having plane directions (X and Y directions) of the layer image and a depth direction (Z direction). A part of the Z stack image data may be extracted so as to generate Z stack image data having a different number of layers, or Z stack image data having a different size on the plane direction.

The Z stack image data is displayed by a viewer, which is observation software. For example, image data on a layer which the observer specified using such a pointing device as a mouse is displayed, and the image data on the layer is displayed so that an area centered around desired X and Y positions is displayed, or a cursor can be moved. Thereby the observer can suitably observe the three-dimensional structure of the test object 101a.

(Operation Environment of the Viewer)

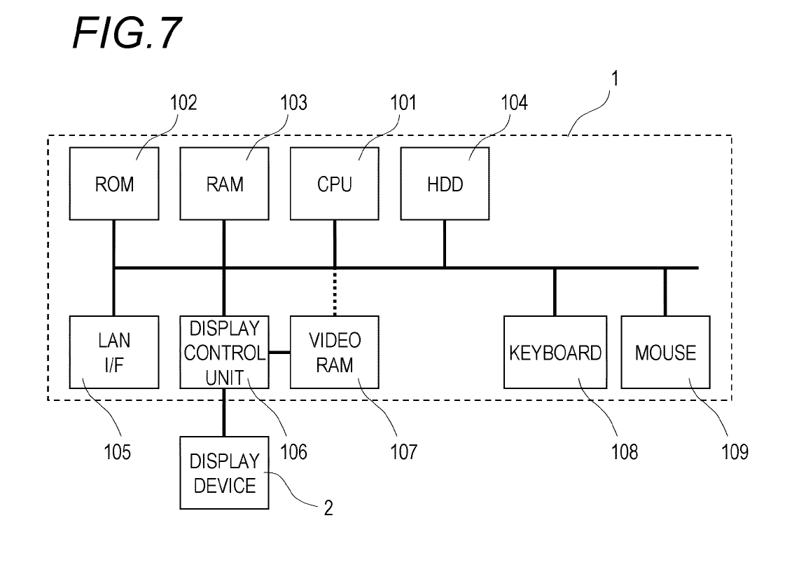

FIG. 7 shows a configuration example of an image observation apparatus according to an embodiment of the present invention. Here the image observation apparatus is implemented by executing a viewer program on a computer system that includes a display device and a pointing device.

In FIG. 7, 1 denotes the computer operated by the viewer, and 2 denotes the display device. The computer 1 has a CPU 101, a ROM 102, a RAM 103, a hard disk drive (HDD) 104, a LAN interface (LAN I/F) 105, a display control unit 106, a video RAM 107, a keyboard 108 and a mouse 109. In the configuration in FIG. 7, the CPU 101 reads and executes observation software (program) called a “viewer”, which is stored in the HDD 104. The viewer program may be stored in the HDD 104 or the ROM 102, or may be downloaded from a server (not illustrated) via the LAN I/F 105 and executed.

If the viewer is started, the CPU 101 acquires image data from the server (not illustrated) via the LAN I/F 105, and stores the image data in the RAM 103. The image data is not limited to being acquired from the server, but may be stored in the HDD 104 of the computer 1, for example. Then as described later, the CPU 101 writes a part of the image data (image data on the display area) stored in the RAM 103 to the video RAM 107 via the display control unit 106, so as to perform a desired display. It may of course be designed such that the CPU 101 can directly write the image data to the video RAM 107, as indicated by a dotted line in FIG. 7. On the other hand, the CPU 101 periodically reads instructions inputted from the keyboard 108 and the mouse 109. According to the instruction from the keyboard 108 or the instruction from the mouse 109, the CPU 101 writes the image data in the display area to the video RAM 107 so as to generate the desired display. In response to the position specified by the mouse 109, a cursor can be displayed on the viewer by writing the data on the cursor to the video RAM 107. The user can recognize the direction of operating the mouse 109 by checking the movement of the cursor. The cursor may be displayed using dedicated hardware of a display control unit 106. Instead of the mouse, other pointing devices, including a touch panel, a touch pad and a track ball, can be used in the same way.

### Embodiment 1

Embodiment 1 of the present invention will now be described. In Embodiment 1 of the present invention, three-dimensional position specification (three-dimensional position pointing) is performed for three-dimensional image data using a conventional pointing device.

The three-dimensional position specification for three-dimensional image data includes, for example, an instruction to move a cursor to a desired position in the three-dimensional image space, and an instruction to move image data displayed on the viewer in any X, Y and Z direction (by dragging, for example). In the following description, an instruction to move the cursor will be described as an example, but the same three-dimensional position specification can be applied to other operation instructions, such as dragging an image. In this embodiment, a mouse is used as the pointing device, but the three-dimensional position specification method of this embodiment can be applied to other pointing devices, including a touch panel, a touch pad and a track ball.

The three-dimensional position specification method for three-dimensional image data according to this embodiment is different from a position specification for a two-dimensional image and other standard two-dimensional position specification methods, such as moving a cursor for operation in an application window. Therefore it is preferable that the observer can switch the three-dimensional position specification method and standard two-dimensional position specification method as required. For example, it is preferable that the observer can switch a mode using a function key of the keyboard 108. Now operation of the mouse in a state where a mode for the three-dimensional position specification method for three-dimensional image data is set will be described.

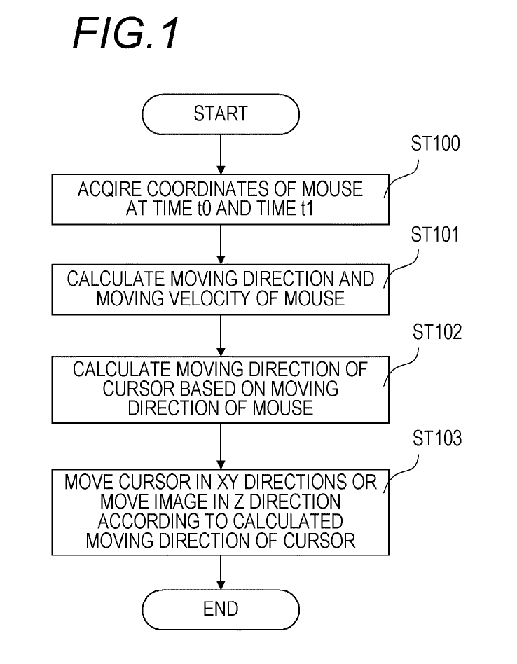

FIG. 1 is a flow chart for implementing operation of a mouse of a viewer according to Embodiment 1 of the present invention. The details on the operation will be described using the flow chart in FIG. 1.

First the CPU 101 determines the coordinates of the mouse 109 at times t0 and t1 (step ST100). Then based on the coordinates of the mouse 109 at times t0 and t1, the CPU 101 determines the moving direction and the moving velocity (step ST101). Then the CPU 101 calculates the cursor moving direction based on the moving direction of the mouse (step ST102). A concrete calculation method will be described later. According to the calculated moving direction of the cursor, the CPU 101 moves the cursor in the X and Y directions, or moves the cursor in the Z direction (step ST103). Moving the cursor in the X and Y directions means changing the display position of the cursor in the plane of the layer image data which is currently displayed. The X direction is the horizontal direction of the image, and the Y direction is the vertical direction of the image. Moving the cursor in the Z direction means changing the layer image data to be displayed. It is preferable that the moving distances of the cursor in the X and Y directions are determined in proportion to the moving velocity of the mouse. It is also preferable that the layer image data is switched in the Z direction for the number of layers or at a velocity in proportion to the moving velocity of the mouse.

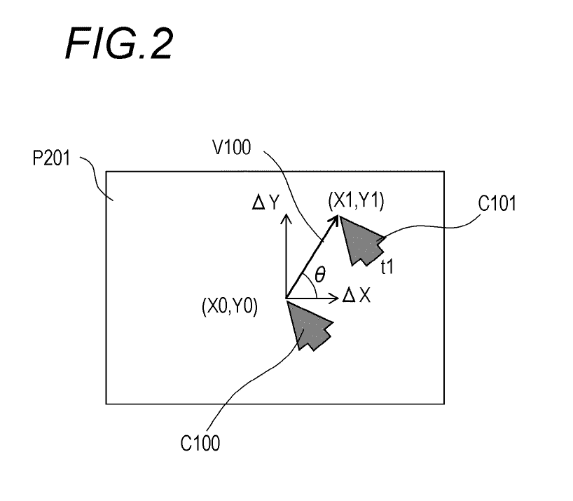

Now a concrete method for determining a moving direction of the mouse and a moving velocity of the mouse based on the coordinates of the mouse 109 at times t0 and t1, described in step ST101 will be described with reference to FIG. 2. FIG. 2 is a schematic diagram depicting the concrete method for determining the moving direction of the mouse and the moving velocity of the mouse. In FIG. 2, C100 shows a position (X0, Y0) of the mouse at time t0, C101 shows a position (X1, Y1) of the mouse at time t1, and V100 is a moving vector of the mouse from time t0 to time t1. In this case, the position of the mouse is determined by counting a clock outputted by the mouse. It is preferable that the coordinates to indicate the position of the mouse are converted into coordinates of a cursor displayed on the display device, for example.

The moving direction of the mouse is the direction of the moving vector (V100), and the moving velocity of the mouse is a value generated by dividing the length of the moving vector (V100) by time (t1−t0). The time t0 and the time t1 are the timings of a timer interrupt, for example, and the CPU 101 checks the moving state of the mouse 109, and calculates a position of the corresponding mouse. It is preferable that the time t0 and the time t1 is appropriately selected based on the velocity operated by the observer. Furthermore, it is preferable that the interval of the time t0 and the time t1 is normally several mSec. to 100 mSec.

The moving direction of the mouse (angle θ in FIG. 2) can be determined by

$$\begin{matrix}[ Math . 1 ] & \\ θ = {tan}^{- 1} ( \frac{Y 1 - Y 0}{X 1 - X 0} ) . & Expression ( 1 )\end{matrix}$$

The moving velocity of the mouse V can be determined by

$$\begin{matrix}[ Math . 2 ] & \\ V = \frac{\sqrt{{( X 1 - X 0 )}^{2} + {( Y 1 - Y 0 )}^{2}}}{t 1 - t 0} . & Expression ( 2 )\end{matrix}$$

Now a concrete method for determining the moving direction of the cursor in step ST102 will be described. It is preferable to determine the moving direction of the cursor.

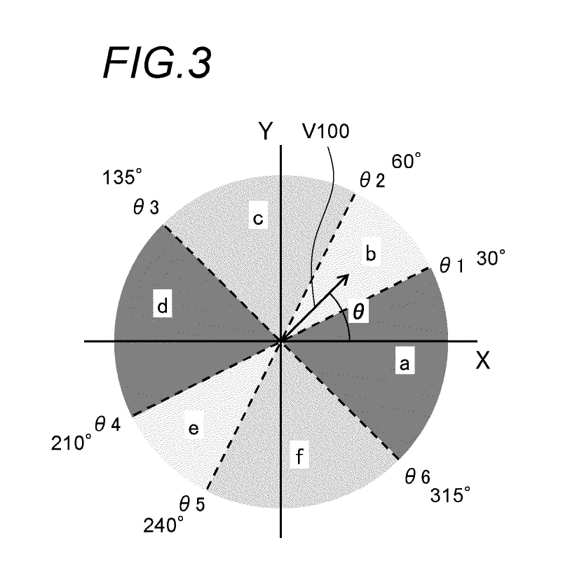

The range of the moving direction θ of the mouse determined by Expression (1) is 0° to 360°, hence the moving direction of the cursor is determined based on the moving direction θ of the mouse, as shown in FIG. 3. FIG. 3 is a diagram showing areas to determine the moving direction of the cursor with respect to the moving direction θ of the mouse, where the abscissa is the X direction of the moving direction of the mouse, the ordinate is the Y direction of the moving direction of the mouse, and an angle formed with the positive direction of the X axis is the moving direction θ of the mouse. In FIG. 3, the dotted line is a boundary line dividing areas, which determines the moving direction of the cursor with respect to the moving direction θ of the mouse, and areas denoted with a to f are areas indicating the determined moving direction of the cursor. The angle of the boundary line from the positive direction of the X axis is θ1 to θ6 respectively, which are determined in such a way that the observer does not feel uncomfortable. For example, θ1 is set to 30°, θ2 is set to 60°, θ3 is set to 135°, θ4 is set to 210°, θ5 is set to 240° and θ6 is set to 315°.

If the moving direction of the mouse is between 315° to 30°, that is in area a, the moving direction of the cursor is determined as “+X direction” (that is the 0° direction). If the moving direction θ of the mouse is between 30° and 60°, that is in area b, the moving direction of the cursor is determined as “−Z direction”. If the moving direction θ of the mouse is between 60° and 135°, that is in area c, the moving direction of the cursor is determined as “+Y direction” (that is the 90° direction). If the moving direction θ of the mouse is between 135° to 210°, that is in area d, the moving direction of the cursor is determined as “−X direction” (that is the 180° direction). If the moving direction θ of the mouse is between 210° to 240°, that is in area e, the moving direction of the cursor is determined as “+Z direction”. If the moving direction θ of the mouse is 240° to 315°, that is in area f, the moving direction of the cursor is determined as “−Y direction” (that is the 270° direction).

In other words, if the mouse is moved roughly in the X direction, it is regarded that a position in the X direction is specified, and if the mouse is moved roughly in the Y direction, it is regarded that a position in the Y direction is specified, and if the mouse is moved in a diagonal direction, it is regarded that a position in the Z direction is specified. In this embodiment, a movement in the first quadrant direction and a movement in the third quadrant direction in the two-dimensional coordinates of X and Y are recognized as a movement in a diagonal direction (movement in the Z direction). Thereby a line that intersects with the X axis or the Y axis at approximately 45° can be regarded as a virtual Z axis. If a moving direction of the cursor is determined like this, the observer can specify a position of the cursor in the depth direction (Z direction) by specifying a position in the Z direction in a way matching with sensibilities of the observer.

The method for determining the moving direction of the cursor based on the moving direction θ of the mouse can be given by the following expressions.

If the moving direction of the mouse is θ, the moving direction of the cursor is determined as the “+X direction” when

θ6≦θ or θ≦θ1 Expression (3)

and is determined as the “−X direction” when

θ3≦θ≦θ4 Expression (4).

The moving direction of the cursor is determined as the “+Y direction” when

θ2≦θ<θ3 Expression (5)

and is determined as the “−Y direction” when

θ5≦θ<θ6 Expression (6).

The moving direction of the cursor is determined as the “+Z direction” when

θ4<θ<θ5 Expression (7)

and is determined as the “−Z direction” when

θ1<θ<θ2 Expression (8).

The moving direction of the cursor can be determined as described above. The calculation including this determination can be easily implemented by the CPU 101 executing an appropriate program.

As described above, the movement of the display image based on the instruction of the cursor and drag operation according to the present invention is limited to the moving directions parallel with the X, Y and Z axes. In other words, operation to move the display image in a diagonal direction on the XY plane cannot be performed. In the case of observing the Z stack image data using a viewer, this limitation of the moving direction is preferable. This is because when observing a test object during pathological diagnosis, the observer (pathologist) observes a partial area of the test object while sequentially moving the area with some overlapped portions. By this observation, the entire area of the test object can be observed without missing any portion. In concrete terms, for this observation, the image of the test object is displayed with fixing the image in the X position and moving in the Y direction. Once observation in the Y direction is completed, the display area is moved only in the X direction with some overlapped portions. Then in the moved X position, the image is displayed and observed while sequentially moving the image in reverse, that is in the Y direction. By repeating this procedure, the entire image of the test object is observed. For an area of interest, adjustment only in the Z direction (focusing position) is possible by moving the mouse, or the like, diagonally. Thus in the case of observing the test object (sample) while moving the image thereof during pathological diagnosis, the three-dimensional position specification method of the present invention, where the moving directions are limited to the direction parallels with the X, Y and Z axes, is preferable.

According to the above mentioned three-dimensional position specification method, three-dimensional positions in the XYZ directions can be specified using a standard pointing device which can perform two-dimensional moving operation in the XY directions. Furthermore, the position in the Z direction is specified by moving the pointing device in the diagonal direction, hence operation is simple, and the operation of the pointing device and the movement of the cursor and the display image match with the sensibilities of the observer. Therefore the observer can concentrate on observation without feeling discomfort when operating the pointing device. In this embodiment, a cursor is used as an example of a moving target moved by the pointing device, but the same method can be used for dragging operation on a display image as a moving target.

### Embodiment 2

Embodiment 2 of the present invention will now be described. As described in Embodiment 1, the viewer has the three-dimensional position specification method mode and the standard position specification method mode. According to Embodiment 2, the position specification method mode in which the viewer is running is displayed.

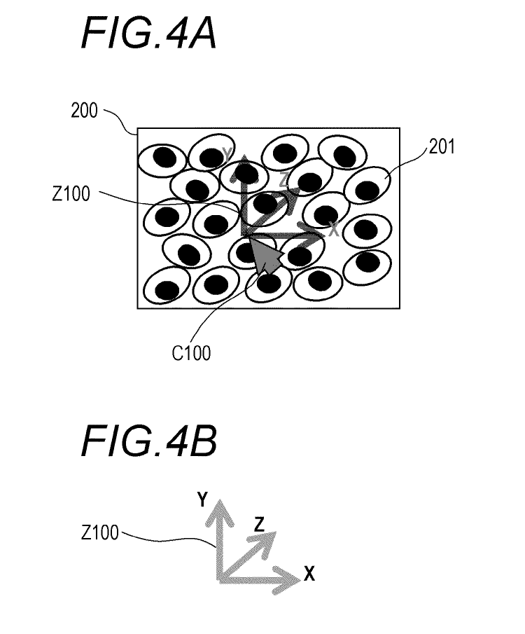

FIG. 4A and FIG. 4B are diagrams depicting an example of displaying a position specification method mode according to Embodiment 2. FIG. 4A is an example when a guide image, to indicate a position specification method mode, is displayed overlapping on an image of the test object current being displayed. FIG. 4B is an example of the guide image. In FIG. 4A, 200 denotes a display window of the viewer where an image is displayed. 201 denotes a test object in the image, C100 denotes a cursor, and 2100 denotes the guide image that is displayed in the three-dimensional position specification method mode. The guide image 2100 of this embodiment also plays a function (role) of an operation guide that describes behavior (action) of the viewer (parallel movement of the cursor position or the display image, or change of the displayed layer) with respect to the operation direction of the pointing device (movement in the XY directions or movement in the diagonal direction).

The guide image Z100 is stored in a ROM 102 or in a hard disk drive 104 as image data. The guide image 2100 is displayed by the CPU 101 reading the data on the guide image when necessary, and writing the data in a video RAM 107 via a display control unit 106.

It is preferable that the guide image 2100 is displayed as a semi-transparent image, overlapping with the image of the test object currently being displayed on the display window 200. It is preferable that this processing is implemented by the computing function of a display control unit 106. Needless to say, this processing can also be implemented by the CPU 101 performing logical operation for the image data of the test object and the image data of the guide image 2100, and additionally writing the operation result in the video RAM 107.

The overlapping display of the guide image 2100 is performed when the three-dimensional position specification method mode described in Embodiment 1 is specified. In the case of the standard position specification method mode, the guide image 2100 is not displayed. In other words, according to this embodiment, the mode is distinguished depending on whether the guide image 2100 is displayed. Needless to say, another guide image to indicate the standard position specification method mode may be provided so that the type of the guide image to be displayed is changed depending on the mode. The position where the guide image 2100 is displayed is preferably near the current cursor position. Another suitable position of the guide image 2100 is a fixed position at a center or lower right of the display screen or display window 200 of the display device, for example.

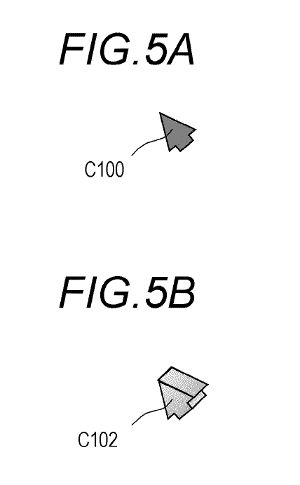

Another preferable method to indicate a position specification method mode is changing the shape of the cursor depending on the mode. FIG. 5A and FIG. 5B show an example. FIG. 5A shows a shape of a cursor (C100) which is displayed in the standard position specification method mode. FIG. 5B shows an example of a shape of a cursor (C102) which is displayed in the three-dimensional position specification method mode. By making the shape of the cursor (C102) three-dimensional, the observer can intuitively recognize that three-dimensional positions can be specified. If the shape of the cursor, which the observer focuses on, is changed like this, the observer immediately distinguishes the current mode, just like the method of displaying the guide image as shown in FIG. 4A.

In the case of the three-dimensional position specification mode, it is preferable that, in order for the observer to know the current moving direction of the cursor and the scrolling direction, color, brightness, shape or the like of the corresponding arrow mark of the guide image in FIG. 4B is changed and displayed, for example, so that the observer easily recognizes the moving direction of the cursor and the scrolling direction. In this case, one of the attributes (e.g. color, brightness, shape) may be changed, or a plurality of attributes may be changed. If a three-dimensional cursor shape, as shown in FIG. 5B, is displayed, it is even better if the orientation or shape of the cursor itself is changed according to the moving direction of the cursor, because the moving direction of the cursor is easily recognized. For example, if the cursor is moved in the X and Y axis directions, the orientation of the cursor itself is matched with the X and Y axis directions of the display screen. If the cursor is moved in the Z direction, the cursor pointing to the upper right direction is displayed to move in the depth direction, and the cursor turning to the lower left direction is displayed to move in the direction toward the observer. The color or brightness of the cursor may be changed at this time.

Since the guide image, which indicates whether the viewer is running in the three-dimensional position specification mode or in the standard mode, is displayed on the viewer like this, the observer can recognize the current mode. Further, the observer can easily confirm the moving direction of the current operation. As a result, the observer can prevent an operation error, and usability improves. There are a choice of guide images to indicate a mode. For example, the color of the cursor may be changed depending on the mode. Or the color or shape of the component of the viewer (e.g. application window, or display window of the viewer) may be changed depending on the mode.

### Embodiment 3

Embodiment 3 of the present invention will now be described. In Embodiment 3 of the present invention, the three-dimensional position specification method and the standard position specification method described in Embodiment 1 or Embodiment 2 can be switched automatically. As in the above mentioned embodiments, an embodiment using a mouse as a pointing device will be described. Needless to say, the present invention can be embodied in the same way even if another pointing device is used.

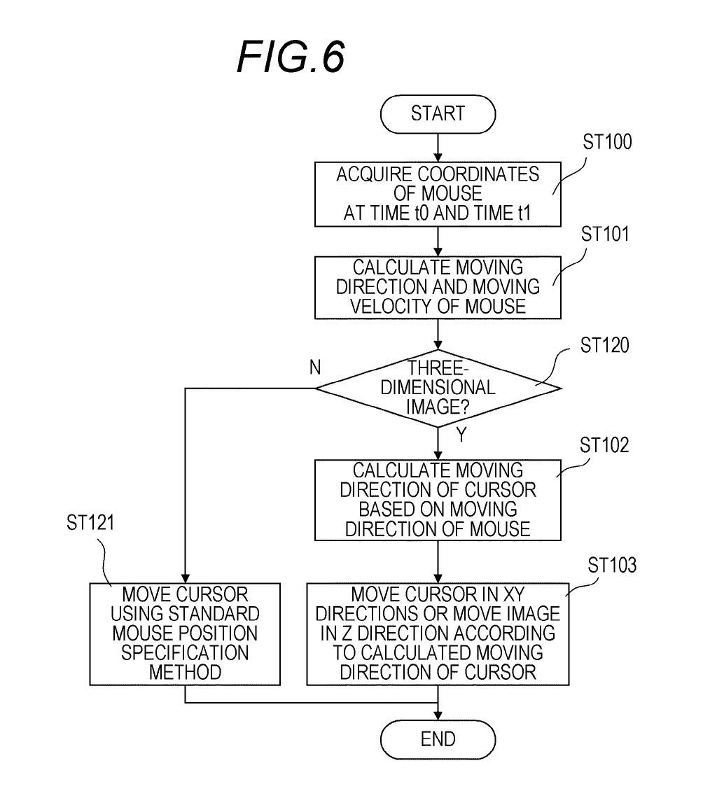

FIG. 6 is a flow chart for implementing operation of a mouse of a viewer according to Embodiment 3 of the present invention. The details on the operation will be described using the flow chart in FIG. 6.

If the CPU 101 detects the mouse 109 moving, the CPU 101 executes the following operation according to the flow chart in FIG. 6. Processing of a step denoted with a same reference numeral as a step in the flow chart in FIG. 1 (ST100, ST101, ST102, ST103) is as described in Embodiment 1. The CPU 101 determines the coordinates of the mouse 109 at times t0 and t1 (step ST100), then determines the moving direction and the moving velocity based on the coordinates of the mouse 109 at times t0 and t1 (step ST101). Then the CPU 101 determines whether the image displayed in the display position of the cursor at time t0 is a three-dimensional image of the test object, that is whether the cursor exists on the three-dimensional image of the test object (step ST120).

If the cursor is on the three-dimensional image, the CPU 101 calculates the moving direction of the cursor based on the moving direction of the mouse, as described in Embodiment 1 (step ST102). Then according to the calculated moving direction of the cursor, the CPU 101 moves the cursor in the X and Y directions, or switches the display layer in the Z direction (step ST103). Details of these processing are the same as those described in Embodiment 1.

If it is determined in step ST120 that the cursor is not on the three-dimensional image, processing advances to step ST121. For example, processing advances to step ST121 if the cursor is outside the display window, or if the image displayed on the display window is a two-dimensional image. In ST121, the standard position specification processing is performed, that is the cursor is moved according to the operation of the mouse.

Thus it is determined whether the position of the cursor is a display position displaying the three-dimensional image of the test object, and the position specification method of the mouse is switched, whereby the observer can select a suitable position specification method by the mouse, without requiring a procedure to switch the mode. As a result, an even more preferable three-dimensional position specification can be performed. The determination processing in step ST120 may be replaced with a determination on whether the display position of the cursor is within the display area of the image of the test object, or a determination on whether the cursor is in the display window of the viewer.

According to Embodiment 3 of the present invention, the mode is switched automatically depending on the position of the cursor. In this case, as described in Embodiment 2, the display of the guide image may be switched automatically as well, responding to the switching of the mode. Since this allows the observer to recognize the switching of the mode, an operation error can be prevented, and usability can be further improved.

The present invention can be suitably applied to a digital microscope system called a “virtual microscope”.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., non-transitory computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-51900, filed on Mar. 8, 2012 and Japanese Patent Application No. 2012-193478, filed on Sep. 3, 2012, which are hereby incorporated by reference herein in their entirety.

What is claimed is:

1. A three-dimensional position specification method for specifying three-dimensional positions in the X, Y and Z directions using a pointing device capable of performing two-dimensional moving operation of a position in the X and Y directions, comprising the steps of:
specifying a position in the X direction by moving the pointing device in the X direction;
specifying a position in the Y direction by moving the pointing device in the Y direction; and
specifying a position in the Z direction by moving the pointing device in a diagonal direction.

2. The three-dimensional position specification method according to claim 1, wherein
the moving in the diagonal direction refers to moving in the first quadrant direction or the third quadrant direction in two-dimensional coordinates of X and Y.

3. A three-dimensional position specification method for specifying three-dimensional positions in the X, Y and Z directions in a viewer which acquires an image in a depth position from three-dimensional image data and displays the image using a pointing device capable of performing two-dimensional moving operation of a position in the X and Y directions, comprising the steps of:
specifying a position in the X direction on the display image by moving the pointing device in the X direction;
specifying a position in the Y direction on the display image by moving the pointing device in the Y direction; and
specifying a position in the depth direction of the display image by moving the pointing device in a diagonal direction.

4. The three-dimensional position specification method according to claim 3, wherein
the moving in the diagonal direction refers to moving in the first quadrant direction or the third quadrant direction in two-dimensional coordinates of X and Y.

5. A three-dimensional position specification method for specifying three-dimensional positions in the X, Y and Z directions using a pointing device capable of performing two-dimensional moving operation of a position in the X and Y directions, comprising the steps of:
a computer determining whether the moving operation by the pointing device is a predetermined moving in the X direction, a predetermined moving in the Y direction, or a predetermined moving in a diagonal direction; and
the computer moving a movement target in the X direction if the moving operation by the pointing device is the moving in the X direction, the computer moving the movement target in the Y direction if the moving operation by the pointing device is the moving in the Y direction, and the computer moving the movement target in the Z direction if the moving operation by the pointing device is the moving in the diagonal direction.

6. A three-dimensional position specification method for specifying three-dimensional positions in the X, Y and Z directions in a viewer which acquires an image in a depth position from three-dimensional image data and displays the image using a pointing device capable of performing two-dimensional moving operation of a position in the X and Y directions, comprising the steps of:
a computer determining whether the moving operation by the pointing device is a predetermined moving in the X direction, a predetermined moving in the Y direction, or a predetermined moving in a diagonal direction; and
the computer moving the display image or a cursor in the X direction if the moving operation by the pointing device is the moving in the X direction, the computer moving the display image or the cursor in the Y direction if the moving operation by the pointing device is the moving in the Y direction, and the computer changing the position of the display image in the depth direction if the moving operation by the pointing device is the moving in the diagonal direction.

7. The three-dimensional position specification method according to claim 6, wherein
the moving in the diagonal direction refers to moving in the first quadrant direction or the third quadrant direction in two-dimensional coordinates of X and Y.

8. The three-dimensional position specification method according to claim 6, wherein
the viewer has a mode in which the pointing device can specify three-dimensional positions in the X, Y and Z directions, and a mode in which the pointing device can specify two-dimensional positions in the X and Y directions, and
the three-dimensional position specification method further comprises the step of the computer displaying, on the viewer, a guide image that indicates a mode in which the viewer is running.

9. The three-dimensional position specification method according to claim 8, wherein
the guide image also plays a function of an operation guide that describes behavior of the viewer with respect to the operation direction of the pointing device.

10. The three-dimensional position specification method according to claim 8, wherein
the guide image is an image of the cursor or an image of a component of the viewer, of which shape or color is different depending on the mode.

11. The three-dimensional position specification method according to claim 8, wherein
the computer changes at least one of color, brightness, shape and orientation of the guide image depending on whether the moving operation by the pointing device is moving in the X direction, moving in the Y direction or moving in the diagonal direction.

12. The three-dimensional position specification method according to claim 8, further comprising the step of the computer allowing the user to specify switching of the mode in which the pointing device can specify three-dimensional positions in the X, Y and Z directions, and the mode in which the pointing device can specify two-dimensional positions in the X and Y directions.

13. The three-dimensional position specification method according to claim 8, further comprising the step of the computer automatically switching the mode in which the pointing device can specify three-dimensional positions in the X, Y and Z directions, and the mode in which the pointing device can specify two-dimensional positions in the X and Y directions, according to the position of the cursor.

14. A non-transitory computer readable medium storing a program for a computer to execute each step of the three-dimensional position specification method according to claim 5.

15. A non-transitory computer readable medium storing a program for a computer to execute each step of the three-dimensional position specification method according to claim 6.
